(19) United States
(12) Patent Application Publication
(10) Pub. No.: US 2014/0181846 A1
(43) Pub. Date: Jun. 26, 2014

(54) COMPUTING DEVICE AND WEB SYSTEM MANAGEMENT METHOD

(71) Applicants: HON HAI PRECISION INDUSTRY CO., LTD., New Taipei (TW); Fu Tai Hua Industry (Shenzhen) Co., Ltd., Shenzhen (CN)

(72) Inventors: QI-DI WU, Shenzhen (CN); YAO-HUA LIU, Shenzhen (CN); XI LIN, Shenzhen (CN); XIAO-SONG LIU, Shenzhen (CN); RONG-RONG PENG, Shenzhen (CN); YUN-YAN WU, Shenzhen (CN); XIAN-YANG QU, Shenzhen (CN); XIN LU, Shenzhen (CN); SHIH-FANG WONG, New Taipei (TW)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/108,340

(22) Filed: Dec. 17, 2013

(30) Foreign Application Priority Data
Dec. 25, 2012 (CN) 201210569472X

(51) Int. Cl. G06F 9/445; G06F 9/45

(52) U.S. Cl. CPC G06F 9/44521; G06F 8/41
USPC 719/331

(57) ABSTRACT

A method manages a web system having a plurality of sub-systems using a computing device. A web project is created for the web system and is stored in a storage of the computing device. Each of the sub-systems has a directory created under the web project. Programs of each sub-system are compiled to generate a dynamic link library (DLL) document of each sub-system. The DLL document of each sub-system is written into a corresponding directory under the web project.

### BACKGROUND

1. Technical Field

Embodiments of the present disclosure generally relate to web system development technologies, and particularly to a computing device and a web system management method.

2. Description of Related Art

Web systems include a plurality of sub-systems to provide different functions. During development of the web system, all of the sub-systems may be established in a web project. When the development of the web system is completed, the web project is compiled to a dynamic link library (DLL) file to publish the web system. However, after the web system has been published, if one or more of the sub-systems need to be maintained or amended, or if a new sub-system is added into the web system, the web project needs to be re-compiled, which may cause other sub-systems to not work temporarily. Therefore, there is room for improvement in the art.

### BRIEF DESCRIPTION OF THE DRAWINGS

FIG. 1 is a schematic block diagram of an exemplary embodiment of a computing device.

FIG. 2 is a flowchart of one embodiment of a web system management method using the computing device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.” The reference “a plurality of” means “at least two.”

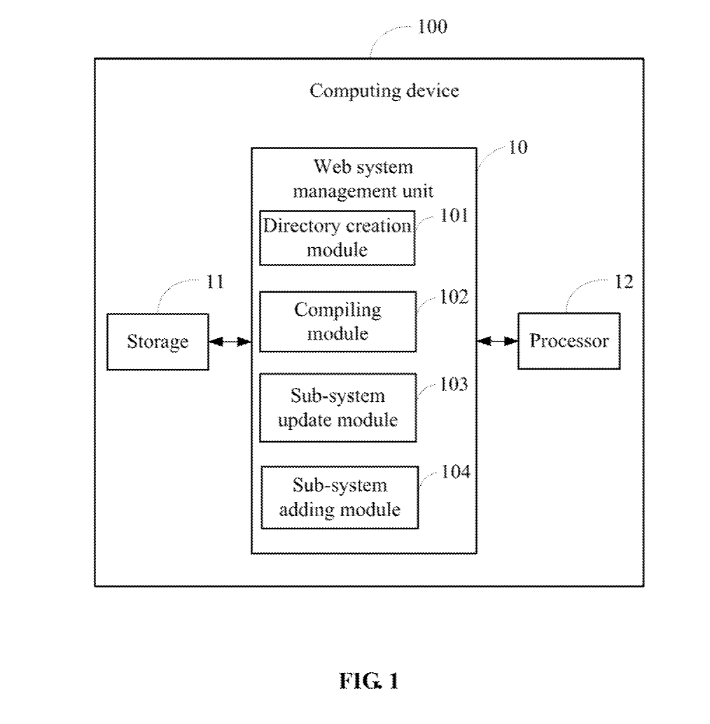

FIG. 1 shows a schematic block diagram of a computing device 100. The computing device 100 can be a computer or a server (e.g., a website server), for example. The computing device 100 includes a web system management unit 10, a storage 11, and a processor 12. The computing device 100 can include more or fewer components than those shown in the embodiment, or have a different configuration of the components.

In this embodiment, the web system management unit 10 comprises a directory creation module 101, a compiling module 102, a sub-system update module 103, and a sub-system adding module 104. The modules 101-104 include computerized codes in the form of one or more programs that are stored in the storage 11 or other storage mediums of the computing device 100. The computerized codes include computer-readable program codes (instructions) that are executed by the processor 12 to provide functions for the computing device 100. The storage 11 can be a cache or a dedicated memory, such as an erasable programmable read-only memory (EPROM), a hard disk drive (HDD), or a flash memory.

In general, the word “module,” as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

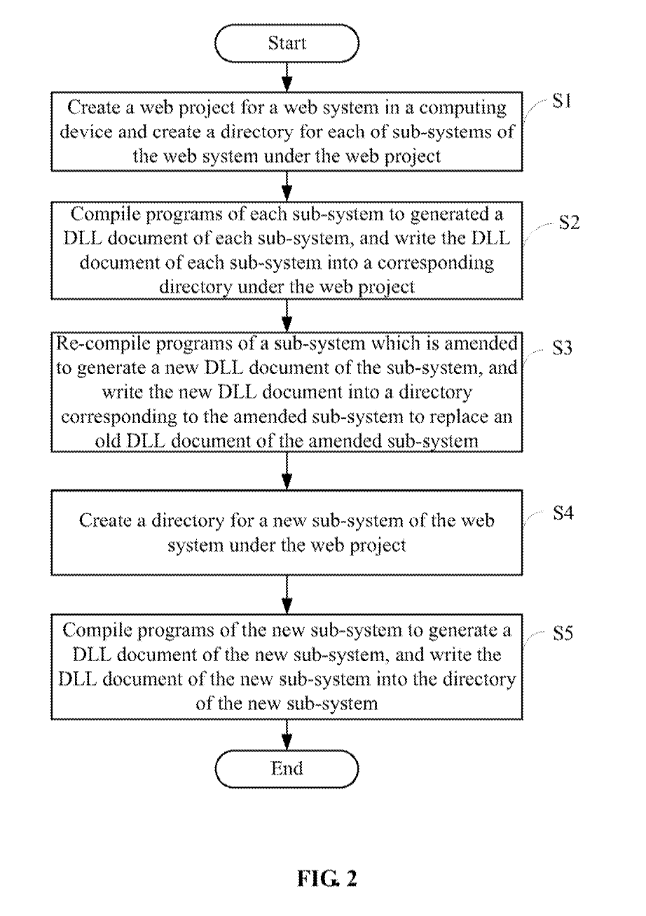

FIG. 2 is a flowchart of one embodiment of a method for publishing a web system using the functional modules of the web system management unit 10 of FIG. 1. Depending on the embodiment, additional steps may be added, others removed, and the ordering of the steps may be changed.

In step S1, the directory creation module 101 creates a web project for a web system in the computing device 100 and creates a directory for each of the sub-systems of the web system under the web project. In this embodiment, the web project and the directory of each sub-system are created and stored in the storage 11 of the computing device 100. The web system includes a plurality of sub-systems to provide different functions. The web project is a web-based application that uses a web browser as a client and is coded in a browser-supported programming language (such as JavaScript, combined with a browser-rendered markup language like HTML) and reliant on a common web browser to render the web-based application executable. The web project is a summation of documents, pages, modules, executable codes, and other elements of the web system stored in a directory of the computing device. Each sub-system comprises a plurality of programs executable by the processor 12 to provide predetermined functions.

In step S2, the compiling module 102 compiles programs of each sub-system to generate a dynamic link library (DLL) document of each sub-system, and writes the DLL document of each sub-system into a corresponding directory under the web project, to publish the web system.

In step S3, when a sub-system is amended, the sub-system update module 103 re-compiles programs of the amended sub-system to generate a new DLL document of the sub-system, and writes the new DLL document into a directory corresponding to the amended sub-system to replace an old DLL document of the amended sub-system. Thus, after the sub-system is amended, the whole web project of the web system does not need to be re-compiled.

In step S4, when the web system has a new sub-system, the sub-system adding module 104 creates a directory for the new sub-system under the web project.

In step S5, the sub-system adding module 104 compiles programs of the new sub-system to generate a DLL document of the new sub-system, and writes the DLL document of the new sub-system into the directory of the new sub-system.

As described above, each of the sub-systems of the web system is compiled to an independent DLL document, and the DLL document of each sub-system is written to different directories. Thus, when any of the sub-systems needs to be amended or maintained, only the corresponding sub-system is re-compiled, so the other sub-systems are not affected and can keep running normally.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for managing a web system having a plurality of sub-systems using a computing device, comprising:
creating a web project for the web system in the computing device and creating a directory for each of the sub-systems of the web system under the web project;
compiling programs of each sub-system to generate a dynamic link library (DLL) document of each sub-system; and
writing the DLL document of each sub-system into a corresponding directory under the web project.

2. The method according to claim 1, further comprising:
re-compiling programs of a sub-system which is amended to generate a new DLL document of the sub-system; and
writing the new DLL document into a directory corresponding to the amended sub-system to replace an old DLL document of the amended sub-system.

3. The method according to claim 1, further comprising:
creating a directory for a new sub-system of the web system under the web project;
compiling programs of the new sub-system to generate a DLL document of the new sub-system; and
writing the DLL document of the new sub-system into the directory of the new sub-system.

4. The method according to claim 1, wherein each of the sub-systems provides one or more different functions for the web system.

5. The method according to claim 1, wherein the web project and the directory of each sub-system are created and stored in a storage of the computing device.

6. The method according to claim 1, wherein the computing device is a computer or a server.

7. The method according to claim 1, wherein the computing device is a website server.

8. The method according to claim 1, wherein the web project is a web-based application that uses a web browser as a client and is coded in a browser-supported programming language and reliant on a common web browser to render the application executable.

9. A computing device, comprising:
a storage;
a processor; and
one or more programs executed by the processor, to perform a method for managing a web system having a plurality of sub-systems, the method comprising:
creating a web project for the web system in the computing device and creating a directory for each of the sub-systems of the web system under the web project;
compiling programs of each sub-system to generate a dynamic link library (DLL) document of each sub-system; and
writing the DLL document of each sub-system into a corresponding directory under the web project.

10. The computing device according to claim 9, wherein the method further comprises:
re-compiling programs of a sub-system which is amended to generate a new DLL document of the sub-system; and
writing the new DLL document into a directory corresponding to the amended sub-system to replace an old DLL document of the amended sub-system.

11. The computing device according to claim 9, wherein the method further comprises:
creating a directory for a new sub-system of the web system under the web project;
compiling programs of the new sub-system to generate a DLL document of the new sub-system; and
writing the DLL document of the new sub-system into the directory of the new sub-system.

12. The computing device according to claim 9, wherein each of the sub-systems provides one or more different functions for the web system.

13. The computing device according to claim 9, wherein the web project and the directory of each sub-system are created and stored in the storage of the computing device.

14. The computing device according to claim 9, wherein the computing device is a computer or a server.

15. The computing device according to claim 9, wherein the computing device is a website server.

16. The computing device according to claim 9, wherein the web project is a web-based application that uses a web browser as a client and is coded in a browser-supported programming language and reliant on a common web browser to render the application executable.
